(19) United States
(12) Patent Application Publication
(10) Pub. No.: US 2019/0039292 A1
(43) Pub. Date: Feb. 7, 2019

(54) PRODUCING THREE-DIMENSIONAL (3D) OBJECTS

(71) Applicant: HEWLETT-PACKARD DEVELOPMENT COMPANY, L.P., Houston, TX (US)

(72) Inventors: James Abbott, Albany, OR (US); David A. Champion, Lebanon, OR (US); Michael G. Monroe, Philomath, OR (US)

(21) Appl. No.: 16/072,136

(22) PCT Filed: Apr. 22, 2016
(86) PCT No.: PCT/US2016/029034

§ 371 Date: Jul. 23, 2018

(51) Int. Cl. B29C 64/165; B29C 64/255; B29C 64/245; B29C 64/218; B29C 64/209; B29C 64/379

(52) U.S. Cl. CPC B29C 64/165; B29C 64/255; B29C 64/245; B33Y 10/00; B29C 64/209; B29C 64/379; B29C 64/218

(57) ABSTRACT

In an example implementation, a method of producing a three-dimensional (3D) object includes patterning an unfused 3D object within a work area of a printing platform and stabilizing the unfused 3D object for removal from the work area.

### BACKGROUND

Additive manufacturing processes can produce three-dimensional (3D) objects by providing a layer-by-layer accumulation and unification of material patterned from a digital model. In 3D printing, for example, digitally patterned portions of successive material layers can be joined together by fusing, binding, or solidification through processes including sintering, extrusion, and irradiation. The quality, strength, and functionality of objects produced by such systems can vary depending on the type of additive manufacturing technology used. Typically, lower quality and lower strength objects can be produced using lower cost systems, while higher quality and higher strength objects can be produced using higher cost systems.

### BRIEF DESCRIPTION OF THE DRAWINGS

Examples will now be described with reference to the accompanying drawings, in which:

FIG. 1a shows an example of a 3D printing system suitable for patterning unfused 3D objects;

FIG. 1b shows an example of a 3D printing system in which markings have been applied to a build volume;

FIG. 1c shows an example of a 3D printing system in which a build volume has been completed and no additional build material has been deposited over the unfused 3D object within the build volume;

FIGS. 2a and 2b show examples of a 3D printing system in which a core drill container has been secured with covers to help stabilize an unfused 3D object;

FIG. 3 shows an example of an assembly that can be constructed within the work area of a 3D printing system;

FIG. 4 shows an example process of an assembly being removed from a work area of a 3D printing system and transferred into a microwave oven for fusing of an unfused 3D object;

FIGS. 5, 6, and 7, are flow diagrams showing example methods of producing a three-dimensional (3D) object.

Throughout the drawings, identical reference numbers designate similar, but not necessarily identical, elements.

### DETAILED DESCRIPTION

In some examples of three-dimensional (3D) printing, 3D objects can be produced by depositing and processing layers of build material. Layers of build material can be successively deposited into a work area such as on a printing platform. A fusing agent can be selectively applied to layers of the build material in areas where the build material is to be fused together. The fusing agent can coat the exterior surface of the build material and penetrate into a layer of build material. The work area can be exposed to fusing energy such as light radiation. The fusing agent is capable of absorbing the fusing energy and converting it into thermal energy. The thermal energy can fuse those areas of the build material on which the fusing agent has been applied. This process can be repeated as each layer of build material is deposited into the work area. Through this process, the work area can include a “build volume” that comprises fused and unfused areas of build material. A 3D object can be formed in this manner from the fused build material.

Three-dimensional printing and other additive manufacturing processes are often used to produce prototype objects. These additive processes are sometimes referred to as rapid prototyping (RP) processes because of their ability to generate complicated shapes within shortened lead times and without the use of special tools. However, the layering technique used in such RP processes, such as the 3D printing process described above, can involve lengthy build times.

The use of microwave energy in additive manufacturing processes can help to reduce the manufacturing time for each part by eliminating the layer-by-layer fusing operations used to bind together the layers of a 3D object. Microwave energy can penetrate opaque materials (unlike visible and infrared light/radiation) and therefore enables the application of energy to an object on a volumetric basis rather than on a layer-by-layer basis. However, when using microwave energy, achieving accurate and robust 3D parts can involve a precise placement of the microwave energy in order to locally fuse the desired build material.

In some examples, an inkjet printing process enables the placement of liquid functional materials with micron level precision to define and/or pattern build material that is to be fused together to form a 3D object. Liquid functional materials can include, for example, microwave absorbing materials called susceptors, and fusing aid materials. Susceptor materials function to heat the build material to enable fusing, while fusing aid materials function to lower the fusing temperature of the build material to enable the build material to be fused at a lower temperature. Susceptor materials can include, for example, ferromagnetic materials such as iron, nickel, cobalt, iron alloys, nickel alloys, cobalt alloys, and steel, or ferrimagnetic materials such as magnetite, nickel-zinc ferrite, manganese-zinc ferrite, and copper-zinc ferrite. Fusing aid materials can include, for example, silica and polymer nanoparticles. A build volume can be formed on a printing or build platform by layering powdered build material into the work area of the platform, as noted above. The build volume can be digitally patterned using liquid functional materials to form an unfused 3D object within the build volume. Defining or patterning an unfused 3D object within the build volume can include selectively jetting, printing, or otherwise depositing a desired liquid functional material, such as a susceptor, onto build material on a layer-by-layer basis as layers of the build material are deposited or spread into the work area of the printing platform.

A 3D object that has been patterned or defined within a build volume on a printing platform comprises an unfused 3D object when no fusing energy has been applied during the layer-by-layer patterning of the object. In some examples, therefore, the unfused 3D object within the build volume can be stabilized and securely removed from the printing platform work area for subsequent fusing. The build volume in which the unfused 3D object is defined can be transferred to a microwave furnace/oven where the unfused 3D object can be fused by a volumetric application of microwave energy to the entire unfused 3D object. During application of microwave energy to the unfused 3D object, the susceptor material facilitates the absorption of the microwave energy and the conversion of the energy into heat, which fuses the layers of build material to form a fused 3D object. As noted above, the fusing aid material can function to lower the fusing temperature of the patterned build material, enabling faster fusing of the 3D object.

In some examples, a method enables the removal of a section of the build volume from the printing platform work area so that an unfused 3D object within the removed section can be securely transferred to a microwave oven for fusing. The unfused 3D object patterned by liquid functional material should be kept stable when it is removed from the printing platform work area and transfer to the microwave oven in order to achieve an accurate and robust fused 3D object. Removing and transferring the entire build volume from the printing platform work area to the microwave oven can be cumbersome and make it difficult to maintain the stability of an unfused 3D object. Selective removal of the patterned, unfused 3D object from the printing platform work area avoids having to transfer the entire build volume to a microwave oven for fusing. Thus, a subsection or portion of the build volume in the printing platform work area that contains an unfused 3D part of interest can be removed and transferred to a microwave oven for fusing. Selectively removing a portion of the build volume that encompasses an unfused 3D object can include inserting a “core drill” container into the build volume to surround the object. The container can then be secured in a manner that stabilizes the unfused 3D object and the additional unpatterned build material within the container that surrounds the object. For example, a capping blade, such as a putty knife or bottom lid, can be slid under or applied to a bottom opening of the core drill container. In some examples a top lid can be applied to a top opening of the core drill container to help secure the undefined build material surrounding the unfused 3D object within the core drill container. The secured core drill container encompassing the unfused 3D object can then be removed from the printing platform work area and transported to the microwave oven for fusing. In some examples, a plurality of unfused 3D objects can be patterned within a build volume, and a corresponding plurality of sections of the build volume can be selectively removed from the printing platform work area using a plurality of corresponding core drill containers. In some examples, a single core drill container can be used to remove a section of a build volume that contains more than one unfused 3D object.

In a particular example, a method of producing a three-dimensional (3D) object includes patterning an unfused 3D object within a work area of a printing platform. The method continues with stabilizing the unfused 3D object for removal from the work area.

In another example, a method of producing a three-dimensional (3D) object includes depositing layers of build material into a work area of a printing platform. A 3D object is patterned from build material within the work area by selectively depositing a liquid functional material (LFM) onto a portion of some of the layers. The 3D object is then enclosed within a removable container.

In another example, an assembly for producing a three-dimensional (3D) object includes patterned build material that forms an unfused 3D object. The assembly additionally includes a container encompassing the unfused 3D object and unpatterned build material surrounding the unfused 3D object.

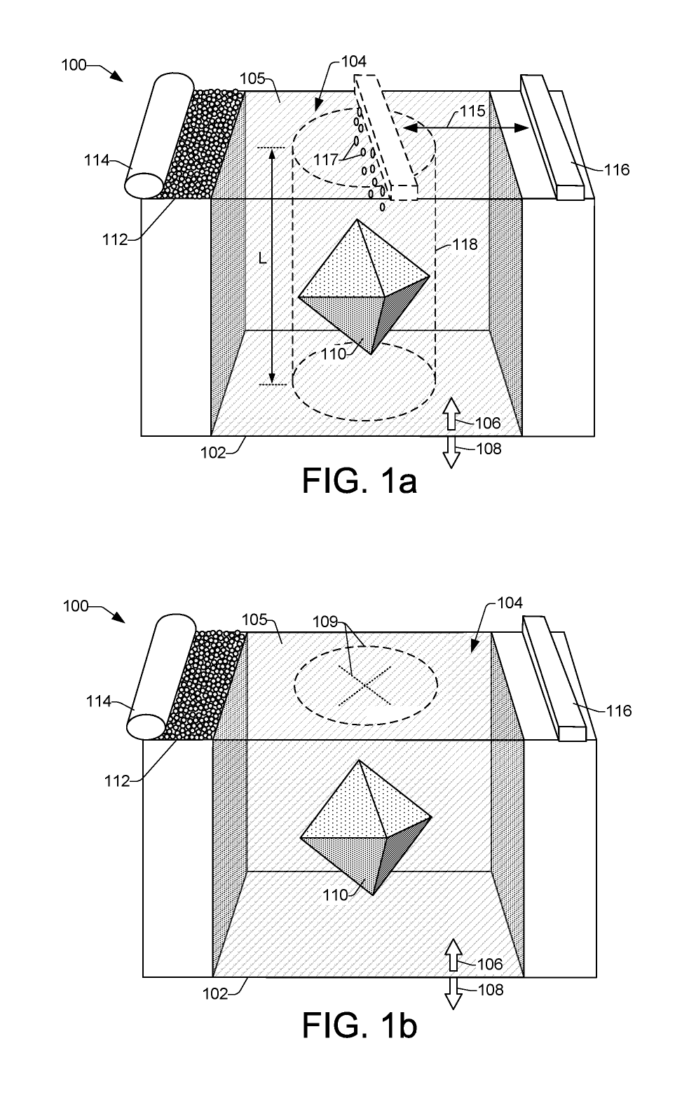

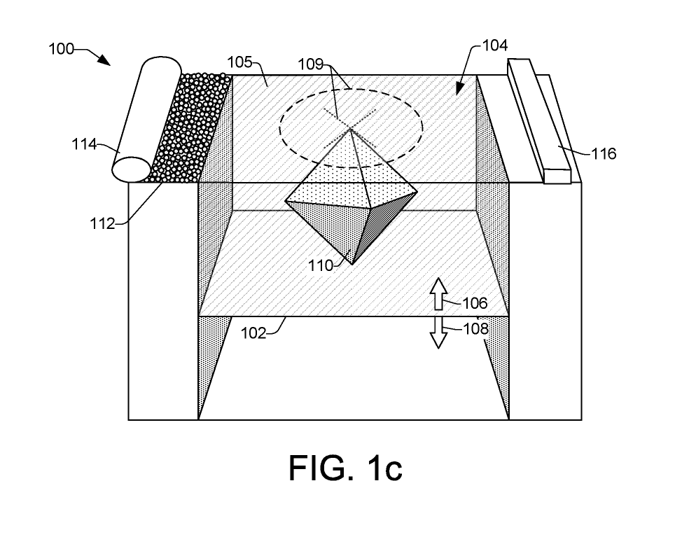

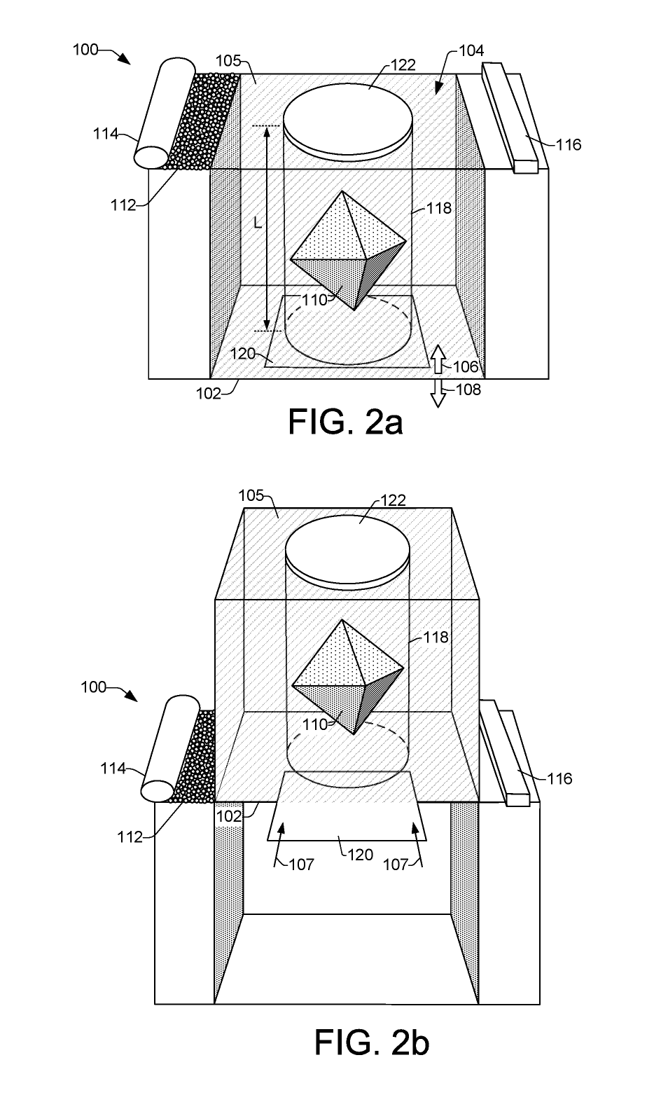

FIG. 1a shows an example of a 3D printing system 100 suitable for patterning unfused 3D objects. The system 100 includes a moveable printing platform 102, or build platform 102. The moveable printing platform 102 serves as the floor to a work area 104 in which 3D objects can be layered and patterned. The moveable printing platform 102 is moveable in an upward direction as indicated by up arrow 106 and in a downward direction as indicated by down arrow 108. The platform 102 in FIG. 1a is shown in a downward position after an unfused 3D object has been patterned. When patterning of an unfused 3D object begins, however, the printing platform 102 can be in an upward position toward the top of the work area 104, and it can move downward as layers of an unfused 3D object are built up. In some examples, as shown in FIG. 2b, the platform 102 can be returned to an upward position after the patterning of a 3D object is completed. When patterning of an unfused 3D object is complete, the printing platform 102 can be in downward position toward the bottom of the work area 104, as shown in FIGS. 1a and 1 b. In some examples, when patterning of an unfused 3D object is complete, the printing platform 102 can be somewhere in the middle of the work area 104, as shown in FIG. 1c. The position of the platform 102 can depend on the size of the unfused 3D object 110 as well as whether build material is to be positioned under and over the unfused 3D object as insulation, for example.

Referring still to FIG. 1a, the system 100 includes a build material supply 112 that feeds build material into the work area 104 as a roller 114 or other type of material spreader spreads the build material into layers over the printing platform 102 and over other layers of build material. The build material in supply 112 can comprise powdered material made from various materials that are suitable for producing 3D objects. Such build materials can include, for example, polymers, glass, ceramics (e.g., alumina, Al₂O₃), Hydroxyapatite, metals, and so on.

As each layer of build material, or powder, is spread onto the printing platform 102 within the work area 104, an inkjet printhead 116 or printheads can scan 115 over the work area 104 in a back and forth manner or in a page-wide array configuration to selectively deposit a liquid functional material (LFM) 117 onto the powder layer in a pattern that forms part of an unfused 3D object 110. In some examples, a liquid functional material 117 can include a susceptor material that will absorb microwave radiation and convert it to heat when the unfused 3D object is transferred to a microwave oven. The heat generated by the susceptor material can cause fusing of the unfused 3D object. In some examples, a liquid functional material 117 can include a fusing aid to lower the fusing temperature of the build material. Examples of fusing aids include alumina nanoparticles, silica nanoparticles, and other materials that enable lower temperature fusing of ceramics.

When the patterning of an unfused 3D object 110 is complete, the work area 104 comprises a build volume 105 sometimes referred to as a powder cake. In some examples, when patterning of an unfused 3D object 110 is complete, additional layers of material can be spread over the object 110 to provide insulation when the object 110 is removed from the work area 104. Thus, as shown in FIGS. 1a and 1b, additional build material can be present over and under the unfused 3D object 110. However, as shown in FIG. 1c, in some examples, there may be no additional build material over an unfused 3D object 110. FIG. 1c shows an example of a 3D printing system 100 in which a build volume 105 has been completed and no additional build material has been deposited over the unfused 3D object 110 within the build volume 105.

In some examples, once patterning of an unfused 3D object is complete, the top of the build volume 105 can be marked, for example, by a printhead 116 ejecting a pattern of ink onto the top layer of the build volume 105. FIGS. 1b and 1c show examples of a 3D printing system 100 in which a build volume 105 has been completed and markings 109 have been applied to the build volume 105. Markings 109 can be applied to the build volume 105 as guides that indicate the location within the build volume 105 of an unfused 3D object 110 and the size (e.g., diameter) and shape of “core drill” container 118 to be used to insert into the build volume 105 to encompass the unfused 3D object, as discussed below.

The build volume 105 within the work area 104 is made up of patterned build material (i.e., patterned powder) that forms an unfused 3D object, and unpatterned build material (i.e., unpatterned powder) that surrounds the unfused 3D object. The patterned 3D object is an unfused 3D object 110 because none of the patterned powder that makes up the 3D object has been fused together. The unfused 3D object 110 can then be removed from the work area 104 and transferred to a microwave oven for fusing. However, because the 3D object is not yet fused, it can be unstable and may suffer deformation or some other alteration if it is not stabilized prior to being removed from the work area 104.

Therefore, as shown in FIG. 1a, a “core drill” container 118 can be inserted into the build volume 105 in the work area 104 and around the unfused 3D object 110 after patterning of the unfused 3D object is completed. As noted above, in some examples, the location of the unfused 3D object as well as the size and shape of core drill container 118 to be inserted can be marked on the build volume 105, as shown in FIGS. 1b and 1c. In addition, the length, L, of the core drill container 118 is such that its top will be at or above the top of the build volume 105 to enable the installation of a top cover, as discussed below. The core drill container 118 is shown using dashed lines in FIG. 1a to indicate that the container 118 is inserted into the work area 104 after the unfused 3D object is finished being patterned. Thus, it should be noted that the core drill container 118 illustrated in FIG. 1a is not inserted into the build volume 105 or present in the work area 104 during patterning of the unfused 3D object 110. Insertion of the core drill container 118 into the work area 104 enables a core portion of the build volume 105 within the work area 104 that includes the unfused 3D object 110 to be captured and removed from the work area 104. In some examples, the core drill container 118 is made of a microwave-transparent material which enables its direct transfer from the work area 104 to a microwave oven for fusing of the unfused 3D object 110. While the core drill container 118 is shown as being a cylindrical container, there are other volumetric shapes for the container that may also be suitable. Thus, other container shapes such as a rectangular box or a triangular prism can also be used as the core drill container 118. In addition, as noted above, in some examples a plurality of unfused 3D objects patterned within a work area 104 can be removed using a plurality of corresponding core drill containers. In such examples, different core drill containers can have different sizes and cross-sectional openings to accommodate objects of different sizes. The core drill container 118 is initially open at both its bottom and top ends to facilitate its insertion into the build volume 105 in the work area 104. The container 118 encompasses both the unfused 3D object 110 and the unpatterned build material powder immediately surrounding the object 110. The unpatterned powder surrounding the unfused 3D object 110 within the container 118 helps to stabilize the unfused 3D object. As discussed below, coverings applied to the core drill container 118 can provide further stability by maintaining the unpatterned powder within the container 118.

FIGS. 2a and 2b show examples of a 3D printing system 100 in which the core drill container 118 has been secured with covers to help stabilize the unfused 3D object 110 during removal from the work area 104 of printing platform 102. As shown in FIG. 2a, a bottom covering 120 has been slipped under, or applied to, the bottom opening of the core drill container 118. The bottom covering 120 can be implemented, for example, as a capping blade, a putty knife, a bottom lid, or another type of seal to secure the bottom opening of the container 118. In some examples, for small geometry build volumes 105, the bottom covering 120 can be slipped under the bottom of the core drill container 118 while the core drill container 118 and build volume 105 remain in the work area 104. In some examples, as shown in FIG. 2b, after the core drill container 118 is inserted into the build volume 105 in work area 104, the moveable printing platform 102 can be moved in an upward direction 106 until the build volume 105 is exposed, enabling the insertion of a bottom covering 120 under the bottom of the core drill container 118, as indicated by direction arrows 107. In some examples, the bottom covering 120 can be placed on the moveable printing platform 102 prior to the beginning of patterning the unfused 3D object 110. Closing off the bottom of the core drill container 118 helps to stabilize the unfused 3D object 110 by preventing the loss and/or disturbance of the 3D object 110 and the unpatterned build material powder that surrounds the object inside the container 118. In addition to a bottom covering 120, a top covering 122 can be applied to the core drill container 118. The top covering 122 can be applied to the core drill container 118 after the container 118 is inserted into the build volume 105 in the work area 104. The length, L, of the core drill container 118 is such that its top will be at or above the top of the build volume 105 to enable the installation of a top covering 122. Examples of top coverings 122 include press-on caps, threaded caps that can be screwed onto the container 118, and so on. Having a top covering 122 on the core drill container 118 prior to inserting the container into the work area 104 can prevent the free movement of unpatterned powder through the container as the container is inserted into the build volume 105 in the work area 104. In some examples where the length, L, of the core drill container 118 exceeds the height of the build volume 105, additional powder can be added into the container 118 prior to applying a top covering 122.

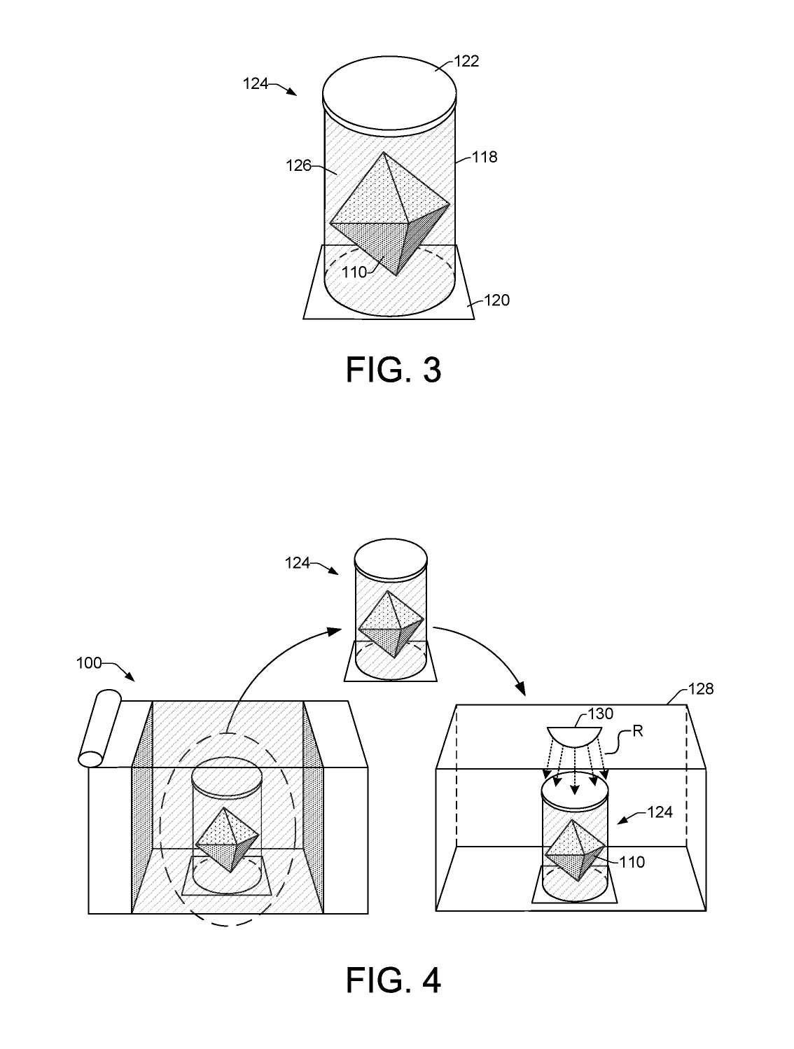

FIG. 3 shows an example of an assembly 124 that can be constructed within the work area 104 of a system 100 after an unfused 3D object 110 has been patterned. The assembly 124 comprises a transport and/or fusing assembly 124 that enables the secure removal of the unfused 3D object 110 from the work area 104 and subsequent transport of the object 110 to a microwave oven for fusing. The assembly 124 includes an unfused 3D object 110 surrounded by unpatterned powder 126 (i.e., unpatterned build material) encompassed within a core drill container 118. The core drill container 118 can comprise any suitable volumetric shape that is initially open at both its bottom and top ends to enable its insertion into a build volume 105 of a work area 104 to encompass an unfused 3D object 110. Examples of suitable shapes include cylindrical shapes, rectangular box shapes, triangle prism shapes, and so on. The unpatterned powder 126 within the container 118 helps to stabilize the unfused 3D object 110 for transport to a microwave oven and to insulate the object 110 to facilitate heating when exposed to microwave radiation in a microwave oven.

The assembly 124 includes a bottom covering 120 as discussed above that can be implemented as a capping blade, a putty knife, a bottom lid, or another type of seal to secure the bottom opening of the core drill container 118. The bottom covering 120 enables the secure removal of the unfused 3D object 110 from the work area 104 and the transporting of the object 110 to a microwave oven for fusing. The assembly 124 also includes a top covering 122 as discussed above that can be applied to the core drill container 118 after the container 118 is inserted into the work area 104. The top covering 122 can comprise a lid or other type of covering that can be affixed to (e.g., screwed onto) the top opening of the core drill container 118 to further stabilize the unfused 3D object 110 by preventing unpatterned power 126 from coming out of the container 118 during removal and transport of the assembly 124 to a microwave oven for fusing. Each of the core drill container 118, the bottom covering 120, and the top covering 122 of the assembly 124 comprises a microwave-transparent material that enables the entire assembly 124 to be moved directly from the work area 104 of a 3D printing system 100 into a microwave oven for fusing.

FIG. 4 shows an example process of an assembly 124 being removed from the work area 104 of a 3D printing system 100 and transferred into a microwave oven 128 for fusing of the unfused 3D object 110. Once in the microwave oven 128, the assembly 124 can be exposed to microwave radiation R from a microwave radiation source 130. The microwave radiation R penetrates the assembly 124 and is applied to the full volume of the unfused 3D object 110. As discussed above, the liquid functional material (LFM) 117 used to pattern the 3D object 110 can include a susceptor material that facilitates the absorption of the microwave radiation R and the conversion of the radiation energy into heat. The heat fuses the patterned build material of the 3D object 110 to produce a solid, fused 3D object. In some examples, as the temperature of the patterned build material of the 3D object 110 increases, the build material itself begins to absorb more of the microwave radiation R on its own, generating more heat and hastening the fusing. The liquid functional material 117 used to pattern the 3D object 110 can also include a fusing aid material that functions to lower the fusing temperature of the patterned build material of the 3D object, as discussed above.

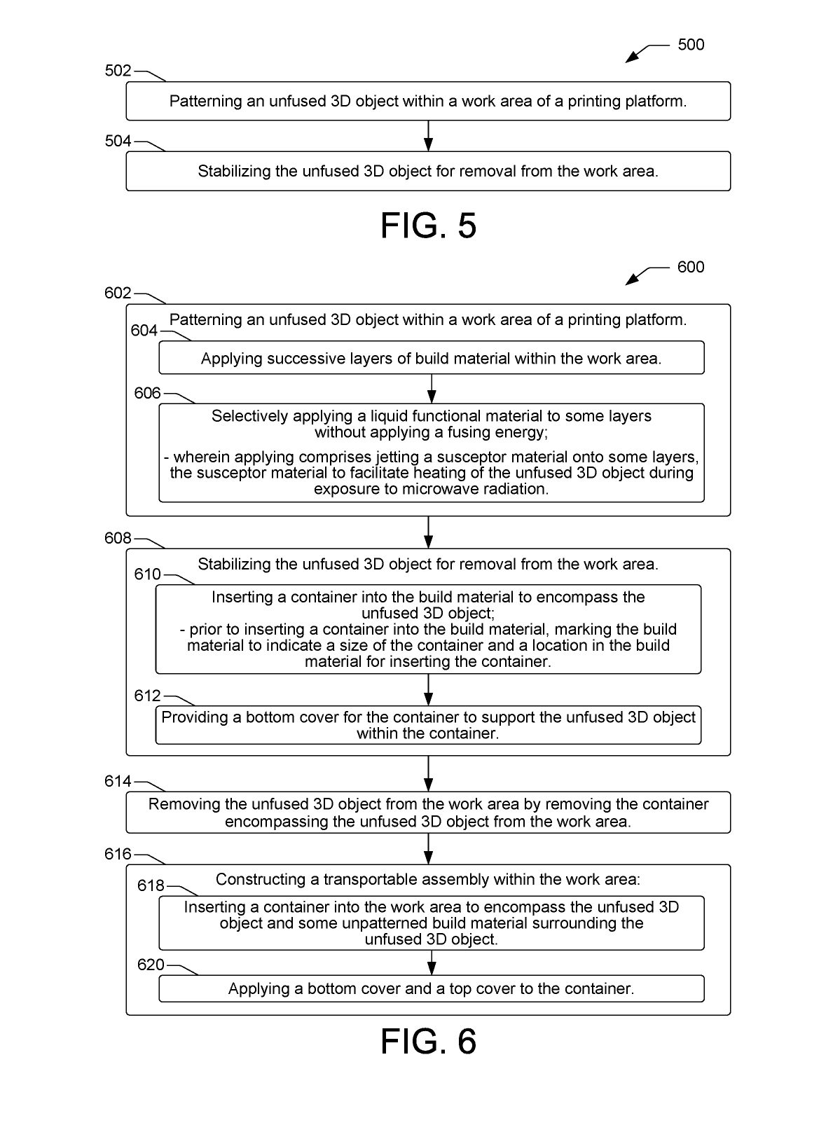

FIGS. 5, 6, and 7, are flow diagrams showing example methods 500, 600, and 700, of producing a three-dimensional (3D) object. Method 600 is an extension of method 500 that incorporates additional details. Referring now to method 500 of FIG. 5, a method of producing a three-dimensional (3D) object includes patterning an unfused 3D object within a work area 104 of a printing platform 102 in a 3D printing system 100 as shown at block 502. The method also includes stabilizing the unfused 3D object for removal from the work area, as shown at block 504.

Referring now to FIG. 6, a method 600 of producing a 3D object provides additional details to method 500. Thus, the method 600 begins at block 602 with patterning an unfused 3D object within a work area 104 of a printing platform 102. In some examples as shown at block 604, patterning an unfused 3D object within a work area can include applying successive layers of powdered build material within the work area. Patterning an unfused 3D object can also include selectively applying a liquid functional material (LFM) to some of the layers without applying a fusing energy to the layers, as shown at block 606. Applying the LFM can include jetting a susceptor material onto some layers, where the susceptor material is to facilitate heating of the unfused 3D object during exposure to microwave radiation.

The method 600 can continue as shown at block 608 with stabilizing the unfused 3D object for removal from the work area. In some examples, stabilizing the unfused 3D object can include inserting a container into a build volume within the work area to encompass the unfused 3D object, and providing a bottom cover for the container to support the unfused 3D object within the container, as shown at blocks 610 and 612, respectively. In some examples, as shown at block 610, prior to inserting a container into the build material, the build material can be marked to indicate a size of the container and a location in the build material for inserting the container. As shown at block 614, the method 600 can include removing the unfused 3D object from the work area by removing the container encompassing the unfused 3D object from the work area. In some examples, the method 600 can include constructing a transportable assembly within the work area, as shown at block 616. Constructing a transportable assembly can include inserting a container into the work area powder bed to encompass the unfused 3D object and some of the unpatterned powdered build material surrounding the unfused 3D object, as shown at block 618. Constructing the assembly can also include applying a bottom cover and a top cover to the container, as shown at block 620.

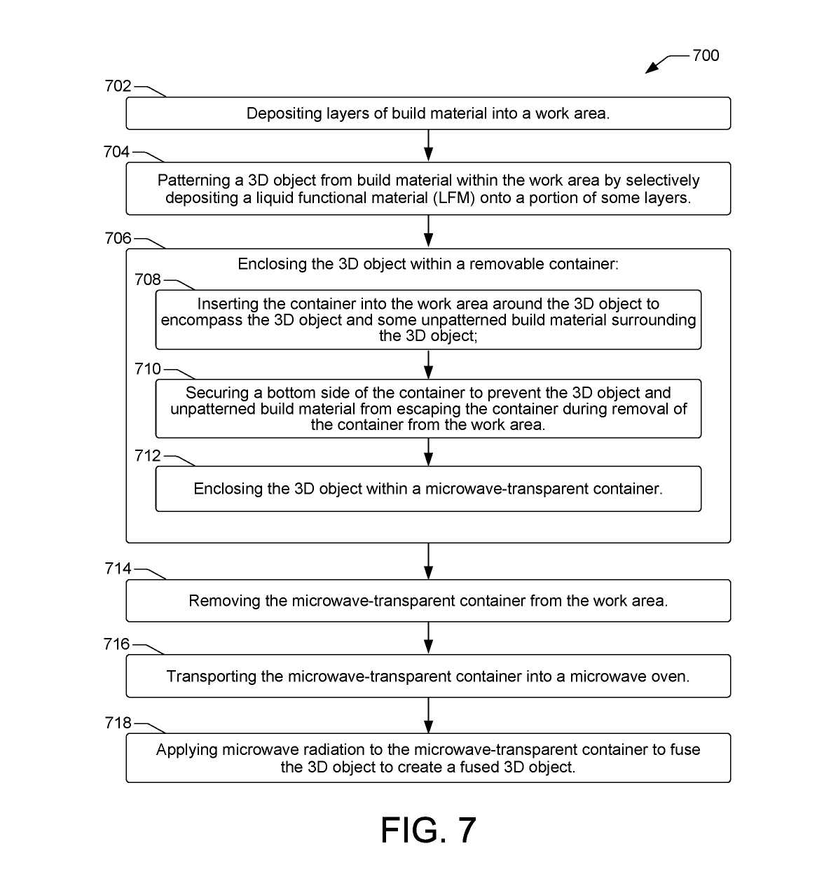

Referring now to method 700 of FIG. 7, a method 700 of producing a three-dimensional (3D) object includes depositing layers of build material into a work area, as shown at block 702. A 3D object can be patterned from build material within the work area by selectively depositing a liquid functional material (LFM) onto a portion of some layers of the build material, as shown at block 704. The method includes enclosing the 3D object within a removable container, as shown at block 706. As shown at block 708, enclosing the 3D object within the container can include inserting the container into the work area around the 3D object to encompass the 3D object and some of the unpatterned build material surrounding the 3D object. Enclosing the 3D object can also include securing a bottom side of the container to prevent the 3D object and unpatterned build material from escaping the container during removal of the container from the work area, as shown at block 710. In some examples, enclosing the 3D object within a removable container includes enclosing the 3D object within a microwave-transparent container, as shown at block 712.

The method 700 can continue with removing the microwave-transparent container from the work area, as shown at block 714. As shown at blocks 716 and 718, respectively, the method can include transporting the microwave-transparent container into a microwave oven, and applying microwave radiation to the microwave-transparent container to fuse the 3D object to create a fused 3D object.

What is claimed is:

1. A method of producing a three-dimensional (3D) object comprising:
patterning an unfused 3D object within a work area of a printing platform; and,
stabilizing the unfused 3D object for removal from the work area.

2. A method as in claim 1, wherein patterning the unfused 3D object comprises:
applying successive layers of build material within the work area; and,
selectively applying a liquid functional material to some of the layers without applying a fusing energy.

3. A method as in claim 1, wherein stabilizing the unfused 3D object comprises:
inserting a container into the build material to encompass the unfused 3D object; and,
providing a bottom cover for the container to support the unfused 3D object within the container.

4. A method as in claim 3, wherein stabilizing the unfused 3D object comprises:
prior to inserting a container into the build material, marking a portion of the build material to indicate a size of the container and a location in the build material for inserting the container.

5. A method as in claim 3, further comprising removing the unfused 3D object from the work area by removing the container encompassing the unfused 3D object from the work area.

6. A method as in claim 2, wherein selectively applying a liquid functional material comprises jetting a susceptor material onto some of the layers, the susceptor material to facilitate heating of the unfused 3D object during exposure to microwave radiation.

7. A method as in claim 1, further comprising constructing a transportable assembly within the work area, the constructing comprising:
inserting a container into the work area to encompass the unfused 3D object and some unpatterned build material surrounding the unfused 3D object; and
applying a bottom cover and a top cover to the container.

8. A method of producing a three-dimensional (3D) object comprising:
depositing layers of build material into a work area of a printing platform;
patterning a 3D object from build material within the work area by selectively depositing a liquid functional material (LFM) onto a portion of some of the layers; and,
enclosing the 3D object within a removable container.

9. A method as in claim 8, wherein enclosing the 3D object comprises:
inserting the container into the work area around the 3D object such that the container encompasses the 3D object and some unpatterned build material surrounding the 3D object; and
securing a bottom side of the container to prevent the 3D object and unpatterned build material from escaping the container during removal of the container from the work area.

10. A method as in claim 9, wherein enclosing the 3D object within a removable container comprises enclosing the 3D object within a microwave-transparent container.

11. A method as in claim 10, further comprising:
removing the microwave-transparent container from the work area;
transporting the microwave-transparent container into a microwave oven; and
applying microwave radiation to the microwave-transparent container to fuse the 3D object to create a fused 3D object.

12. An assembly for producing a three-dimensional (3D) object, the assembly comprising:
patterned build material forming an unfused 3D object; and
a container encompassing the unfused 3D object and unpatterned build material surrounding the unfused 3D object.

13. An assembly as in claim 12, further comprising:
a bottom cap to support the unfused 3D object and the unpatterned build material within the container during removal and transport of the container; and,
a top cap to cover a top opening of the container to prevent loss of the unpatterned build material from the container during removal and transport of the container.

14. An assembly as in claim 11, wherein the patterned build material comprises a plurality of powder layers, each layer patterned by a liquid functional material selectively deposited thereon.

15. An assembly as in claim 14, wherein:
the container comprises a microwave-transparent container; and,
the liquid functional material comprises a susceptor material to facilitate heating of the patterned build material when the unfused 3D object is exposed to microwave radiation.
